(19) United States
(12) Patent Application Publication
(10) Pub. No.: US 2018/0103614 A1
(43) Pub. Date: Apr. 19, 2018

(54) HUMAN-PET INTERACTION SYSTEM

(71) Applicant: JETEAZY SYSTEM CO., LTD., Hsinchu City (TW)

(72) Inventor: Cheng-Hsin TSAI, Hsinchu City (TW)

(21) Appl. No.: 15/293,483

(22) Filed: Oct. 14, 2016

(51) Int. Cl. A01K 15/02; H04N 21/472; H04N 21/41; H04N 21/422; H04N 9/87; H04N 5/64; A01K 1/035; A01K 63/00

(52) U.S. Cl. CPC A01K 15/025; H04N 21/47217; H04N 21/4126; H04N 21/4222; A01K 63/006; H04N 9/87; H04N 5/642; A01K 1/035; H04N 21/42221

(57) ABSTRACT

A human-pet interaction system includes a pet container, a display apparatus, a speaker, and a user apparatus. The pet container has a side plate. The display apparatus is disposed on the pet container, and has a display panel and a processing module connected to the display panel. The display panel is disposed on the side plate, and has a display surface facing to an interior of the pet container. The speaker is connected to the processing module. The user apparatus transmits an audio and video control signal to the processing module to control the display panel and the speaker to play audio and video data contents. Accordingly, the user apparatus plays vivid and various audio and video data contents on the display panel and/or through the speaker so as to attract pets' attention and activate pets' motions and facial expressions, thus increasing interaction between pets and keepers.

### FIELD

The present disclosure relates generally to a human-pet interaction system, and more particularly to a human-pet interaction system having a function of playing audio and video data contents.

### BACKGROUND

This section provides background information related to the present disclosure which is not necessarily prior art.

With the improvement of living standard and the need for releasing pressure, along with the declining birth rate and increasing aged population, keeping pets has become a trend nowadays. Further, pets, such as pet fish, pet dogs, pet cats, pet rabbits, or pet mice, are treated like family members or friends.

Since the development of technology has enhanced convenience and popularity of electronic devices, pet owners may interact with pets through the electronic devices and no longer just by using interactive toys and feeding. Accordingly, the present disclosure provides a human-pet interaction system that may improve traditional monotonous and dull interaction between pets and keepers thereof.

### SUMMARY

This section provides a general summary of the disclosure, and is not a comprehensive disclosure of its full scope or all of its features.

An aspect of the present disclosure is to provide a human-pet interaction system to improve traditional monotonous and dull interaction between pets and keepers thereof.

In order to achieve the above-mentioned aspect, the human-pet interaction system includes a pet container, a display apparatus, a speaker, and a user apparatus. The pet container has a side plate that is transparent. The display apparatus is disposed on the pet container. The display apparatus has a display panel and a processing module. The display panel is disposed on the side plate, and the display panel has a display surface facing to an interior of the pet container. The processing module is electrically connected to the processing module. The speaker is electrically connected to the processing module. The user apparatus transmits an audio and video control signal to the processing module to control the display panel and the speaker to play audio and video data contents.

Accordingly, the human-pet interaction system provides vivid and various audio and video data contents on the display panel and/or through the speaker so as to attract pets' attention and activate pets' motions and facial expressions, thus increasing interaction between pets and keepers thereof.

It is to be understood that both the foregoing general description and the following detailed description are exemplary, and are intended to provide further explanation of the present disclosure as claimed. Other aspects, advantages, and features of the present disclosure will be more apparent from the following description and drawings.

### DRAWINGS

The drawings described herein are for illustrative purposes only of selected embodiments and not all possible implementations, and are not intended to limit the scope of the present disclosure.

FIG. 1 is a schematic view of a human-pet interaction system according to a first embodiment of the present disclosure;

FIG. 2 is a schematic view of the human-pet interaction system according to a second embodiment of the present disclosure;

FIG. 3 is a schematic view of a connection between a user apparatus and a display apparatus and a speaker according to the present disclosure;

FIG. 4 is a schematic view of a connection between the user apparatus and a processing module according to the present disclosure;

FIG. 5 is a schematic view of a connection between the user apparatus and the processing module or a cloud server host according to the present disclosure;

FIG. 6 is a schematic view of a user interface generated on a display screen of the user apparatus according to the present disclosure;

FIG. 7A is a schematic view of showing a functional item “PLAY VIDEO” according to a first embodiment of the present disclosure;

FIG. 7B is a schematic view of showing the functional item “PLAY VIDEO” according to a second embodiment of the present disclosure;

FIG. 7C is a schematic view of showing the functional item “PLAY VIDEO” according to a third embodiment of the present disclosure;

FIG. 7D is a schematic view of showing the functional item “PLAY VIDEO” according to a fourth embodiment of the present disclosure;

FIG. 8A is a schematic view of showing a functional item “PLAY ANIMATION” according to a first embodiment of the present disclosure;

FIG. 8B is a schematic view of showing the functional item “PLAY ANIMATION” according to a second embodiment of the present disclosure;

FIG. 8C is a schematic view of showing the functional item “PLAY ANIMATION” according to a third embodiment of the present disclosure;

FIG. 8D is a schematic view of showing the functional item “PLAY ANIMATION” according to a fourth embodiment of the present disclosure;

FIG. 9 is a schematic view of showing a functional item “PLAY HISTORY” according to the present disclosure;

FIG. 10 is a schematic view of showing a functional item “SYSTEM SETTING” according to the present disclosure; and

FIG. 11 is a schematic view of showing a “SYNCHRONOUS PLAY” operation according to the present disclosure.

### DETAILED DESCRIPTION

Example embodiments will now be described more fully with reference to the accompanying drawings.

Reference will now be made to the drawing figures to describe the present disclosure in detail.

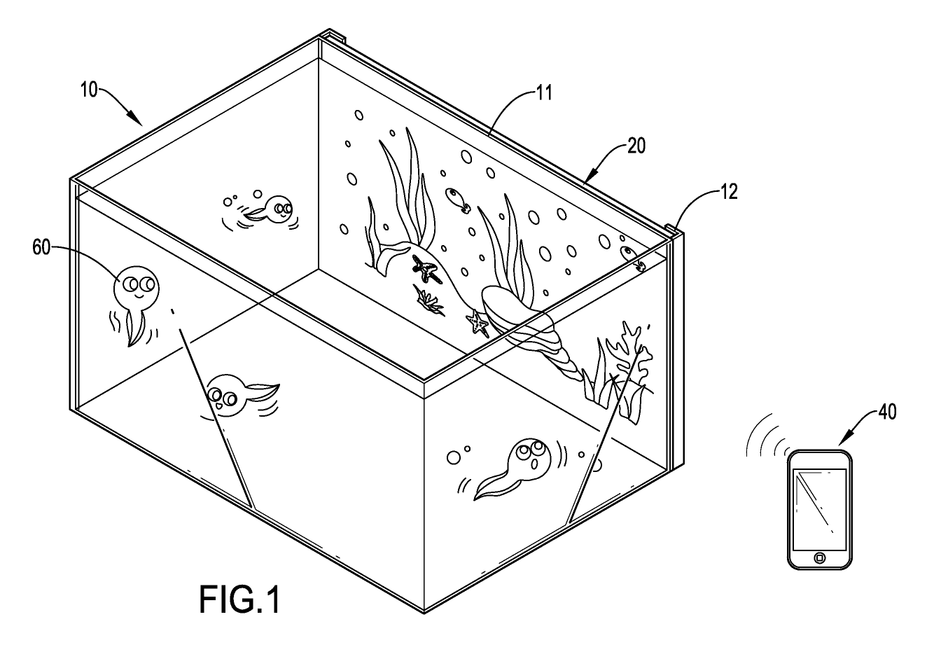

As shown in FIG. 1, a human-pet interaction system of the present disclosure is applied to pet fish 60. In particular, a user, such as a keeper of the pet fish 60 interacts with the pet fish 60 through the human-pet interaction system.

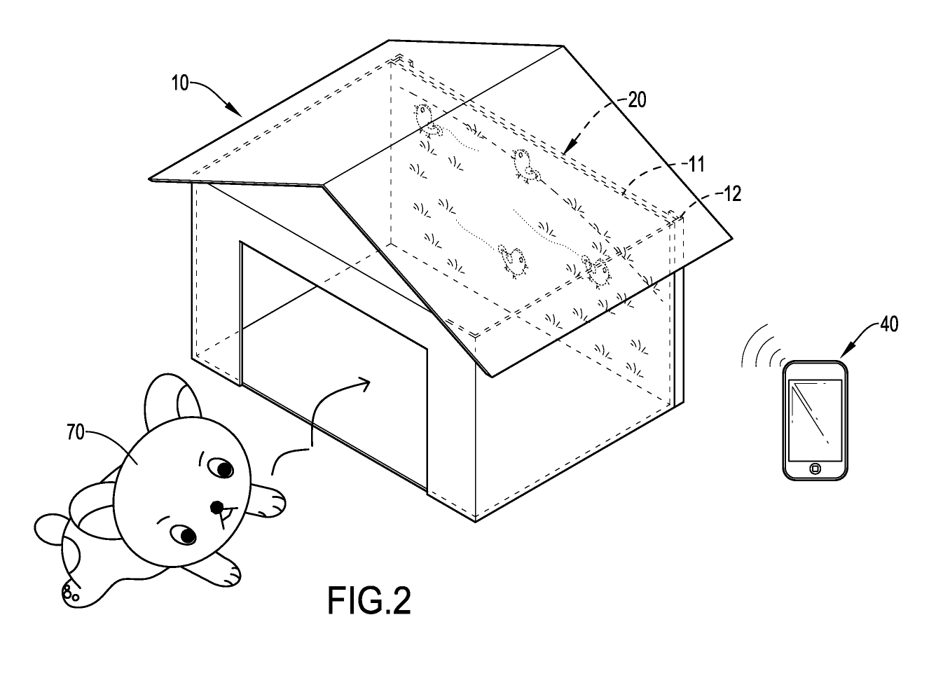

As shown in FIG. 2, the human-pet interaction system of the present disclosure is applied to a pet dog 70. In particular, a user, such as a keeper of the pet dog 70 interacts with the pet dog 70 through the human-pet interaction system. In addition, the human-pet interaction system may be further applied to, but not limited to, pet cats, pet rabbits, or pet mice.

As shown in FIG. 1 or FIG. 2, the human-pet interaction system includes a pet container 10, a display apparatus 20, a speaker 30, and a user apparatus 40. The pet container 10, such as a pet box, a pet house, or a pet cage is used to provide a space for the pet(s). For example, the pet container 10 shown in FIG. 1 is used to accommodate the pet fish 60. In addition, the pet container 10 shown in FIG. 2 is used to accommodate the pet dog 70. The pet container 10 may be designed in different shapes, sizes, or capacities depending on requirements of different pets. The pet container 10 has a plurality of plates. As shown in FIG. 1, the pet container 10 has four side plates and a bottom plate.

As shown in FIG. 1 or FIG. 2, the display apparatus 20 is disposed on the pet container 10. In particular, the display apparatus 20 is disposed on one side plate 11 of the pet container 10, wherein the side plate 11 is made of a transparent material. For example, the side plate 11 may be a transparent glass plate or a transparent acrylic plate. In this embodiment, the display apparatus 20 is disposed on an outer surface of the side plate 11. The human-pet interaction system further provides at least one fixing element 12. In this embodiment, two fixing elements 12 are disposed on two ends of the outer surface of the side plate 11, respectively. Also, the two fixing elements 12 and the outer surface of the side plate 11 form a slot structure so that the display apparatus 20 is inserted into the slot structure. In the present disclosure, the display apparatus 20 may be, but not limited to, a liquid crystal display (LCD), a plasma display panel (PDP), or a light-emitting diode display (LED display). In particular, an apparatus is used as the display apparatus 20 as long as the apparatus has a function of playing videos, animations, or images.

Further, the number and the location of the display apparatus 20 are not limited to the illustrations of FIG. 1 and FIG. 2. For example, the number of the display apparatus 20 may be more than two, and these display apparatuses 20 are disposed on different side plates of the pet container 10. In addition, the display apparatus 20 is not limited to be disposed on the outer surface of the side plate 11, i.e., the display apparatus 20 may be also disposed on an inner surface of the side plate 11. Also, the display apparatus 20 may further provide a waterproof function and/or a scratch-resistant function so that the display apparatus 20 may be disposed on the inner surface of the side plate 11 of the pet container 10.

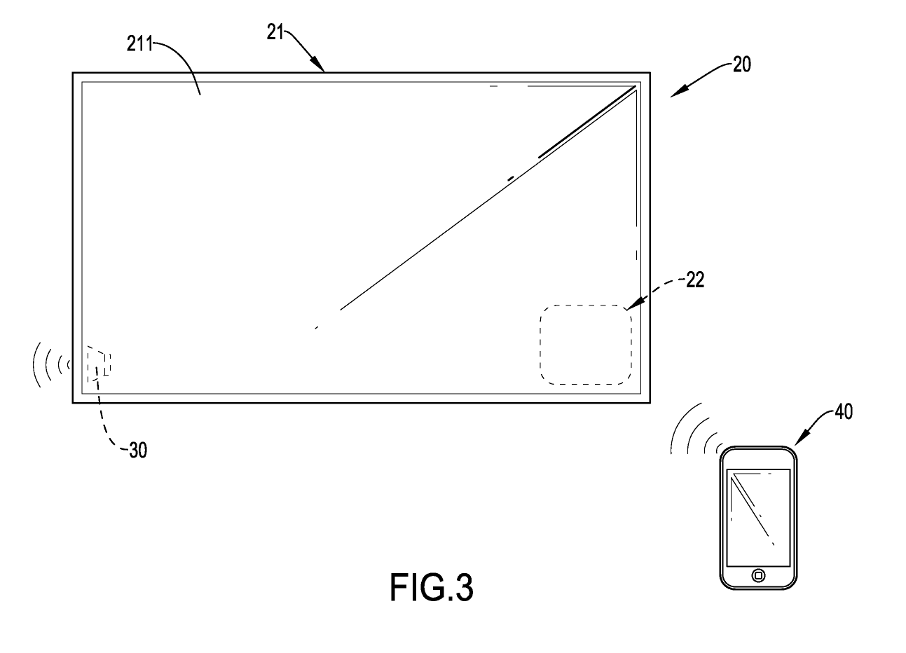

As shown in FIG. 3, the display apparatus 20 includes a display panel 21 and a processing module 22. The display panel 21 is disposed on the side plate 11 and the display panel 21 has a display surface 211 that is provided to display videos, animations, and images. Further, the display surface 211 faces to an interior of the pet container 10 for the pet fish 60 or the pet dog 70 to look at and indirectly touch on the display surface 211. The processing module 22 is electrically connected to the display panel 21 for processing data contents of videos, animations, and images to be played on the display panel 21. The speaker 30 is electrically connected to the processing module 22, and the processing module 22 is used for processing data contents of music and sounds to be played through the speaker 30. In particular, the speaker 30 may be disposed inside a case of the display apparatus 20 or on the case of the display apparatus 20. Further, the speaker 30 may be disposed on the outer surface or the inner surface of any one of the side plates.

As shown in FIG. 1 or FIG. 2, the user, such as a pet owner, operates the user apparatus 40 to interact with the pet fish 60 or the pet dog 70. In particular, the user apparatus 40 may be, but not limited to, a smart phone, a tablet computer, a notebook computer, or a personal computer. In particular, an apparatus is used as the user apparatus 40 as long as the apparatus has a wireless communication function or a wired communication function. In the present disclosure, the user apparatus 40 is operated by the user through a wireless communication manner (as shown in FIG. 1 or FIG. 2) to interact with the pet fish 60 or the pet dog 70. In addition, the user apparatus 40 is operated by the user through a wired communication manner (not shown in FIG. 1 or FIG. 2) to interact with the pet fish 60 or the pet dog 70.

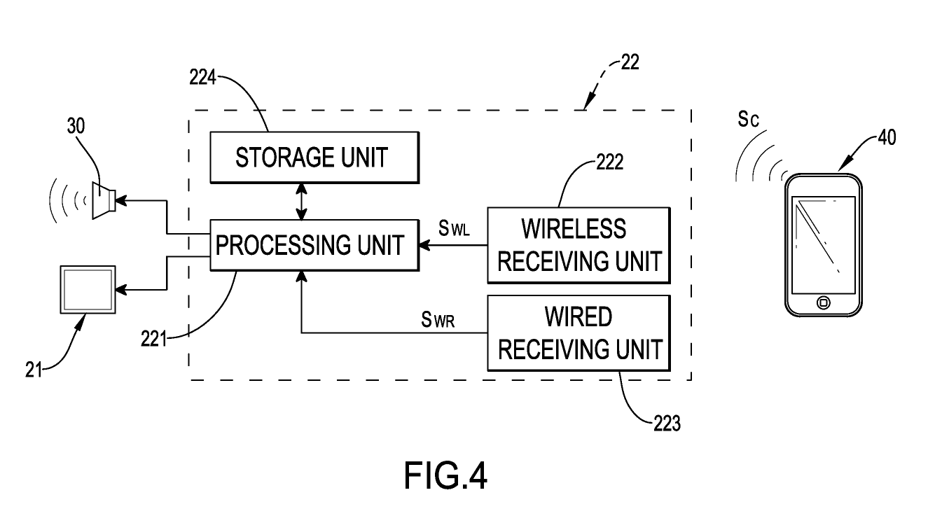

As shown in FIG. 4, the processing module 22 includes a processing unit 221, a wireless receiving unit 222, a wired receiving unit 223, and a storage unit 224. As mentioned above, the user apparatus 40 transmits an audio and video control signal S_{C} to the processing module 22 when the user operates the user apparatus 40 to interact with the pet fish 60 or the pet dog 70. Accordingly, the audio and video control signal S_{C} is provided to control playing the audio and video data contents corresponding to the audio and video control signal S_{C} from the display panel 21 and/or the speaker 30, as described below.

The wireless receiving unit 222 is connected to the processing unit 221 to receive the audio and video control signal S_{C} in a wireless communication manner from the user apparatus 40 and produce a wireless control signal S_{WL} according to the audio and video control signal S_{C}. More specifically, the wireless receiving unit 222 receives the audio and video control signal S_{C} transmitted from the user apparatus 40 in the wireless communication manner. In particular, the wireless communication manner may be implemented by infrared (IR) communication, Bluetooth communication, Beacon communication, near field communication (NFC), radio frequency identification (RFID) communication, Wi-Fi communication, ZigBee communication, or 3G, 4G, or higher generation communication. Also, a signal type of the audio and video control signal S_{C} corresponds to the signal type of the wireless communication signal. Accordingly, the wireless receiving unit 222 receives the audio and video control signal S_{C} in the wireless communication manner to produce the wireless control signal S_{WL}.

In addition, the user apparatus 40 may be connected to the processing module 22 through a wired communication manner. The wired receiving unit 223 is connected to the processing unit 221 to receive the audio and video control signal S_{C} in a wired communication manner from the user apparatus 40 and produce a wired control signal S_{WR} according to the audio and video control signal S_{C}. More specifically, the wired receiving unit 223 receives the audio and video control signal S_{C} transmitted from the user apparatus 40 in the wired communication manner. In particular, the wired communication manner, i.e., a physical communication manner, may be implemented by high definition multimedia interface (HDMI) communication, universal serial bus (USB) communication, or power line communication (PLC). Also, a signal type of the audio and video control signal S_{C} corresponds to the signal type of the wired communication signal. Accordingly, the wired receiving unit 223 receives the audio and video control signal S_{C} in the wired communication manner to produce the wired control signal S_{WR}. For convenience of explanation, the wireless communication manner is exemplified below.

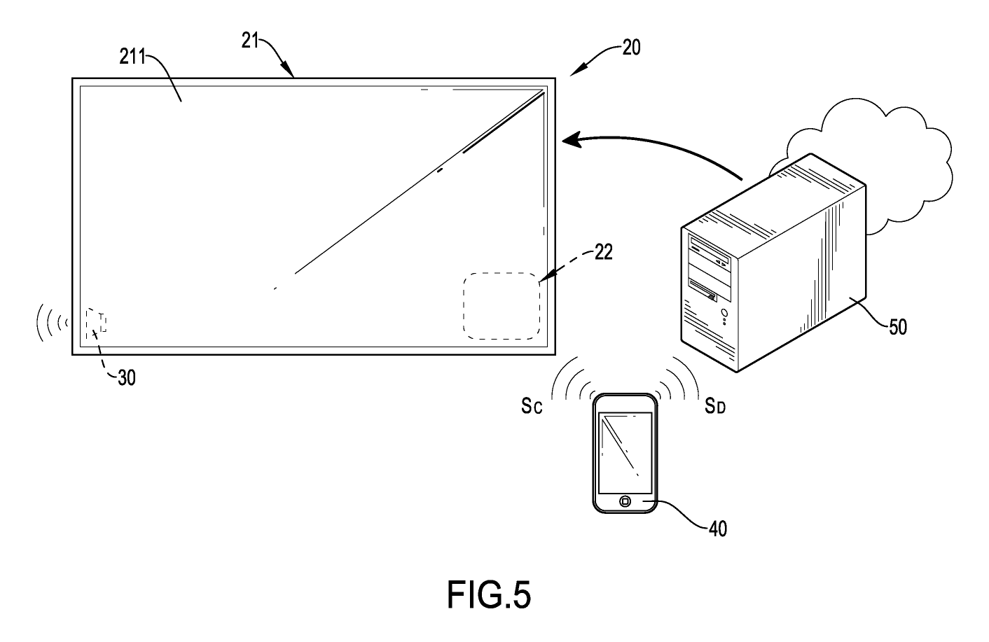

The storage unit 224 is connected to the processing unit 221 for storing the audio and video data contents. More specifically, the storage unit 224 is used to store the audio and video data contents, including videos, animations, images, music, and/or sounds which would be played on the display panel 21 or through the speaker 30. In particular, the storage unit 224 may be a built-in memory, or an external secure digital memory card (SD), micro SD, or flash memory card. Accordingly, the audio and video data contents may be stored in the storage unit 224 by transmitting from the user apparatus 40, or the audio and video data contents may be stored in the storage unit 224 by downloading from a cloud communication service shown in FIG. 5.

The processing unit 221 receives the wireless control signal S_{WL} or the wired control signal S_{WR} to output the audio and video data contents from the display panel 21 or the speaker 30 according to the wireless control signal S_{WL} and/or the wired control signal S_{WR}. More specifically, the wireless control signal S_{WL} based on the wireless communication manner or the wired control signal S_{WR} based on the wired communication manner includes selected information corresponding to data contents of videos, animations, images, music, and/or sounds to be played. Accordingly, the processing unit 221 reads the audio and video data contents stored in the storage unit 224 corresponding to the wireless control signal S_{WL} or the wired control signal S_{WR}, and transmits the audio and video data contents read by the processing unit 221 to display on the display panel 21 and/or through the speaker 30.

As shown in FIG. 5, the user apparatus 40 is further connected to a cloud server host 50 via the Internet. In addition, the processing module 22 of the display apparatus 20 is connected to the cloud server host 50 in a wireless communication manner. As mentioned above, the data contents of videos, animations, or images outputted by the display panel 21 and/or the data contents of music or sounds outputted by the speaker 30 may be downloaded from the cloud server host 50. More specifically, the user apparatus 40 is operated by the user to output a data download signal S_{D} to control the audio and video data contents stored in the cloud server host 50 to be downloaded to and stored in the storage unit 224 of the processing module 22 for display by the display panel 21 and/or through the speaker 30.

In addition, the user apparatus 40 transmits the audio and video data contents stored in the user apparatus 40 to be stored in the storage unit 224 according to the audio and video control signal S_{C}. More specifically, the user apparatus 40 is connected to the processing module 22 through the wired communication manner, and the audio and video data contents stored in the user apparatus 40 are transmitted to and stored in the storage unit 224 of the processing module 22 for display by the display panel 21 and/or through the speaker 30. The wired control signal S_{WR} outputted from the wired receiving unit 223 involves operation information of displaying the audio and video data contents when the audio and video control signal S_{C} is transmitted through the wired communication manner.

In addition, the user apparatus 40 is connected to the processing module 22 through the wireless communication manner, and the audio and video data contents stored in the user apparatus 40 are transmitted to and stored in the storage unit 224 of the processing module 22 for display on the display panel 21 and/or through the speaker 30. The wireless control signal S_{WL} outputted from the wireless receiving unit 222 involves operation information of displaying the audio and video data contents when the audio and video control signal S_{C} is transmitted through the wireless communication manner.

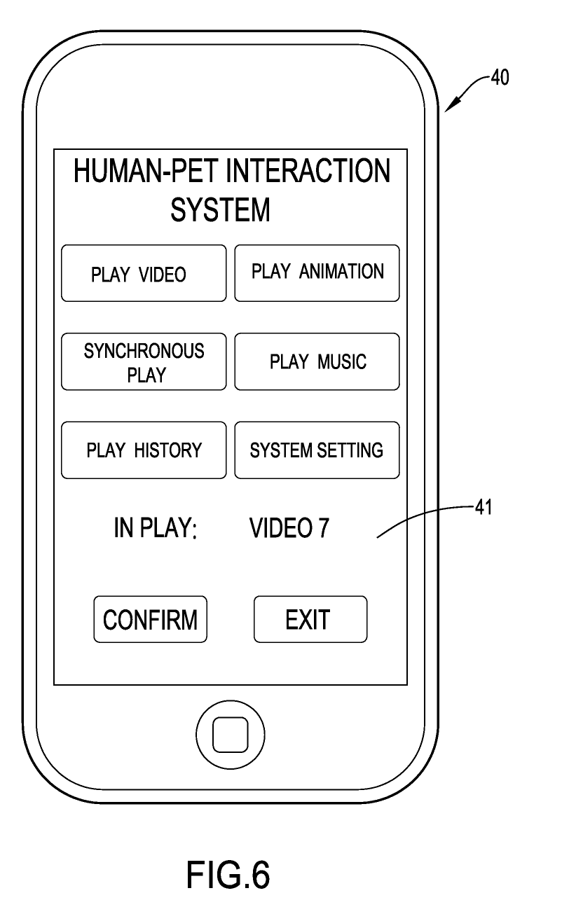

As shown in FIG. 6, a human-pet interaction application (APP) is downloaded and installed on the user apparatus 40. A user of the user apparatus 40 may execute the human-pet interaction application to play the audio and video data contents, download the audio and video data contents, and transmit the audio and video data contents. For example, a user interface 41 is provided on a display screen (not shown) of the user apparatus 40 when the user executes the human-pet interaction application. Also, the user interface 41 shows functional items of “PLAY VIDEO”, “PLAY ANIMATION”, “SYNCHRONOUS PLAY”, “PLAY MUSIC”, “PLAY HISTORY”, and “SYSTEM SETTING” thereon. The above-mentioned functional items are explained below, respectively.

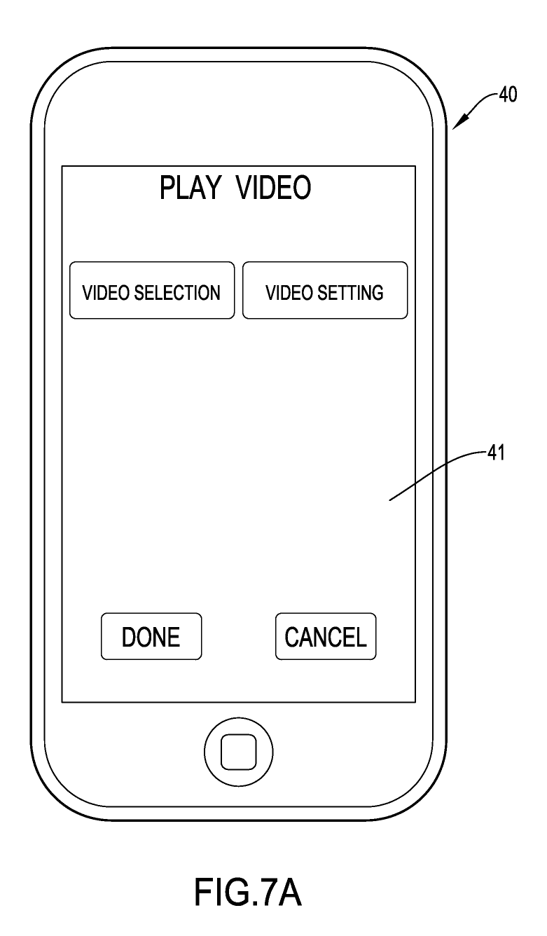

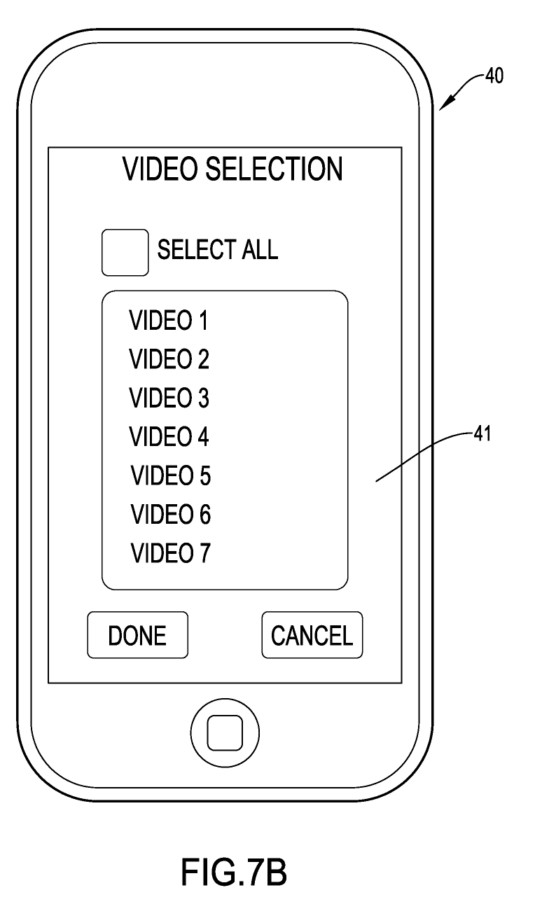

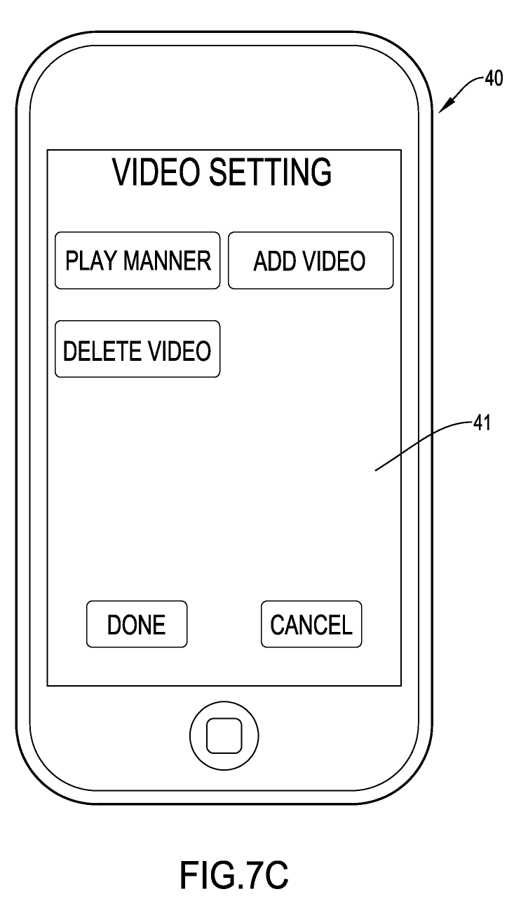

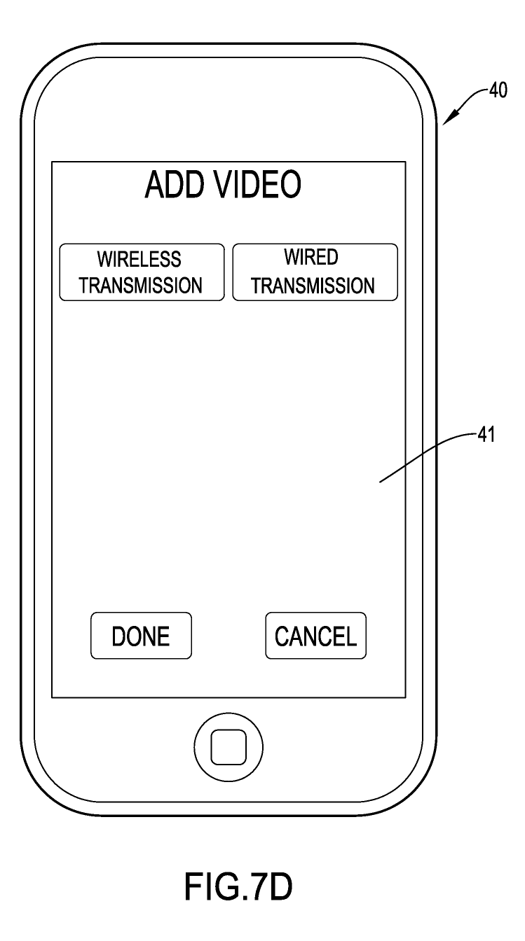

As shown in FIG. 7A to FIG. 7D, the functional item “PLAY VIDEO” is disclosed. As shown in FIG. 7A, the user interface 41 further shows functional items “VIDEO SELECTION” and “VIDEO SETTING” when the user selects “PLAY VIDEO” shown in FIG. 6. As shown in FIG. 7B, the videos going to be played could be selected when the user selects “VIDEO SELECTION”. Afterward, the user may select one single video or multiple videos by selecting the corresponding video files, or select all videos by selecting “SELECT ALL”. In particular, the videos listed on the user interface 41 correspond to the audio and video data contents stored in the storage unit 224 of the processing module 22 by synchronization so that the videos selected by the user could be displayed on the display panel 21. In addition, “VIDEO 1”, “VIDEO 2”, and so on named on the user interface 41 is only exemplified. Actually, user-defined names of the corresponding videos listed on the user interface 41 are clear and convenient to select for the user.

As shown in FIG. 7C, the user interface 41 further shows functional items “PLAY MANNER”, “ADD VIDEO”, and “DELETE VIDEO” when the user selects “VIDEO SETTING” shown in FIG. 7A to set up the video play setting. In particular, the function of “PLAY MANNER” provides manners of sequential play, random play, repeat one, repeat all, and so on.

As shown in FIG. 7D, the user interface 41 further shows functional items “WIRELESS TRANSMISSION” and “WIRED TRANSMISSION” when the user selects “ADD VIDEO” shown in FIG. 7C to decide a communication manner of transmitting added video files. As mentioned above, the video files may be added through the wireless communication manner or the wired communication manner as shown in FIG. 7D. When the user selects “WIRED TRANSMISSION” shown in FIG. 7D, the video files stored in the user apparatus 40 are transmitted to and stored in the storage unit 224 through the wired communication manner. Alternatively, the video files stored in the cloud server host 50 are transmitted to and stored in the storage unit 224 when the user selects “WIRELESS TRANSMISSION” shown in FIG. 7D. In particular, a physical connection with a connector is necessary to interface between the user apparatus 40 and the processing module 22.

Similarly, the video data contents stored in the storage unit 224 may be deleted through the wireless communication manner or the wired communication manner when the user selects “DELETE VIDEO” shown in FIG. 7C.

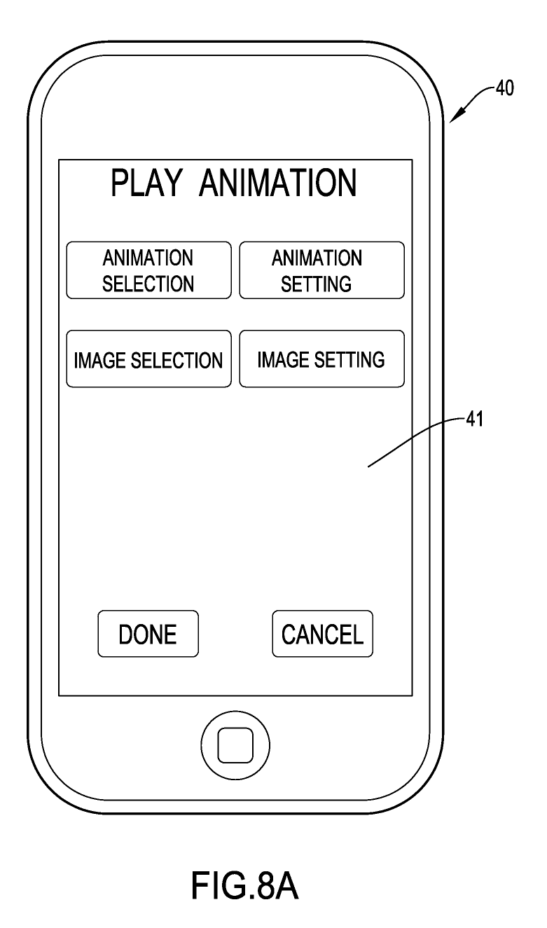

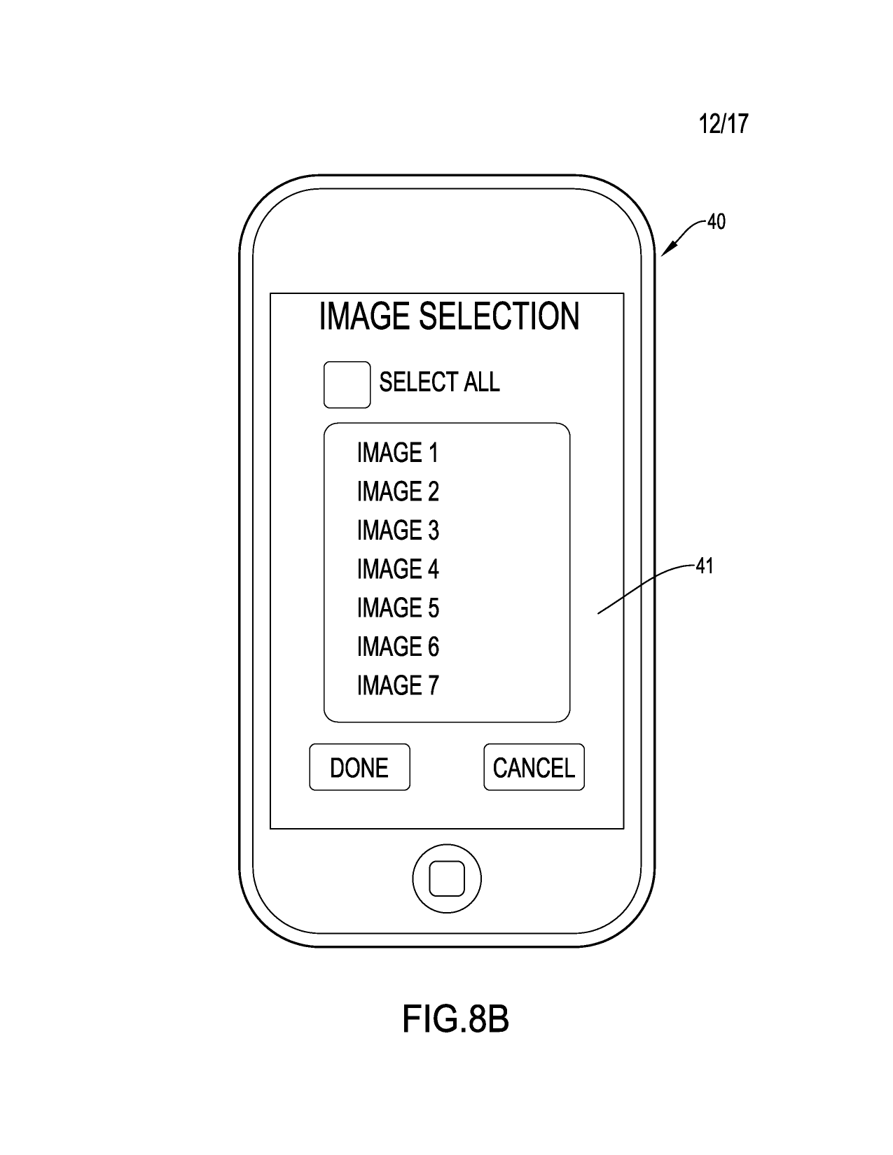

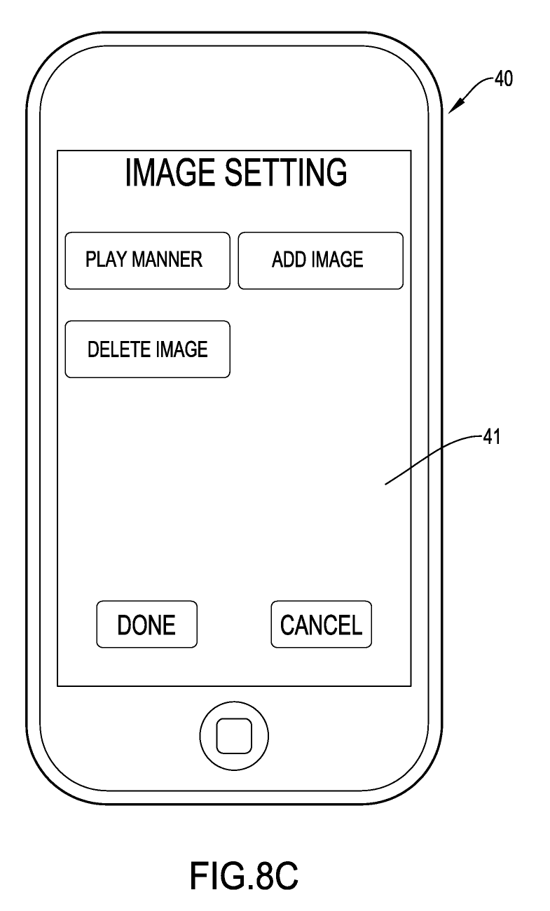

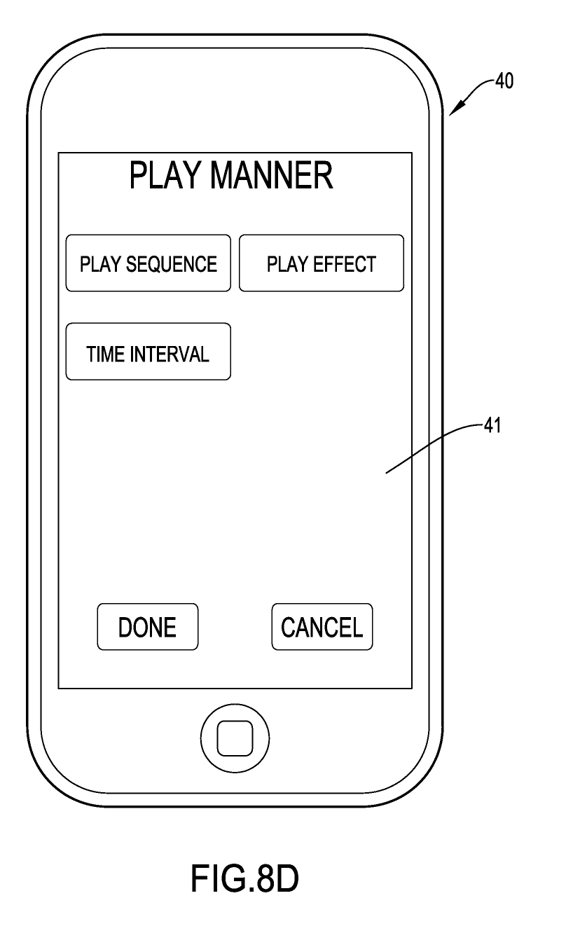

As shown in FIG. 8A to FIG. 8D, the function of “ANIMATION PLAY” is disclosed. As shown in FIG. 8A, the user interface 41 further shows functional items “ANIMATION SELECTION”, “ANIMATION SETTING”, “IMAGE SELECTION”, and “IMAGE SETTING” when the user selects “ANIMATION PLAY” shown in FIG. 6. Since an animation is the process of making the illusion of motion and change by means of the rapid display of a sequence of static images that minimally differ from each other, the functional item of playing images may be classified into “ANIMATION PLAY”. Further, since the manual operations of “ANIMATION SELECTION” and “ANIMATION SETTING” are substantially identical to the manual operations of “VIDEO PLAY” and “VIDEO SETTING”, the detail description is omitted here for conciseness.

As shown in FIG. 8B, the user may further select one single image or multiple images by selecting the corresponding image files, or select all images by selecting “SELECT ALL” when the user selects “IMAGE SELECTION” shown in FIG. 8A. As shown in FIG. 8C, the user interface 41 further shows functional items of “PLAY MANNER”, “ADD IMAGE”, and “DELETE IMAGE”. As shown in FIG. 8D, the user interface 41 further shows functional items of “PLAY SEQUENCE”, “PLAY EFFECT”, and “PLAY INTERVAL” when the user selects “PLAY MANNER” shown in FIG. 8C.

When the user selects “PLAY SEQUENCE”, the selected images may be played in manners of sequential play, random play, repeated play, and so on. When the user selects “PLAY EFFECT”, the manners of appearance, disappearance, and movement of images may be set. When the user selects “PLAY INTERVAL”, time intervals of appearing/disappearing between images may be adjusted.

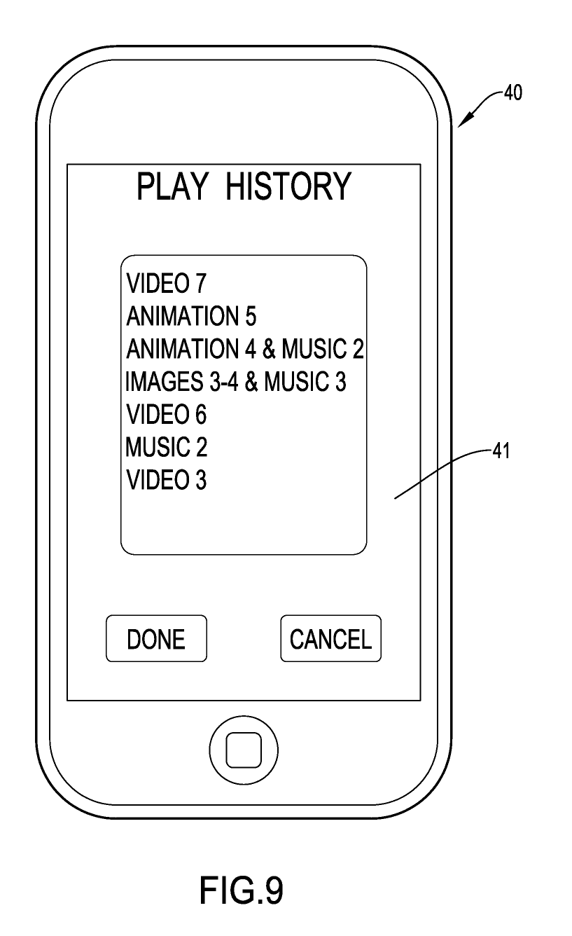

As shown in FIG. 9, the functional item “PLAY HISTORY” is disclosed. The user interface 41 further shows a played list when the user selects “PLAY HISTORY” shown in FIG. 6. The latest played audio and/or video record is shown in the top list. Therefore, it is convenient and efficient for the user to select the favorite, frequently played, or recently played audio and video data contents. In addition, the functional items of “PLAY ANIMATION” and “PLAY MUSIC” may be coordinately selected and set since the selected animation files, including images files and the selected music, including sound effects may be simultaneously played on the display panel 21 and through the speaker 30, respectively. Further, the currently playing audio and video data contents shown on the user interface 41 is clear and concise for the user, as shown in FIG. 6.

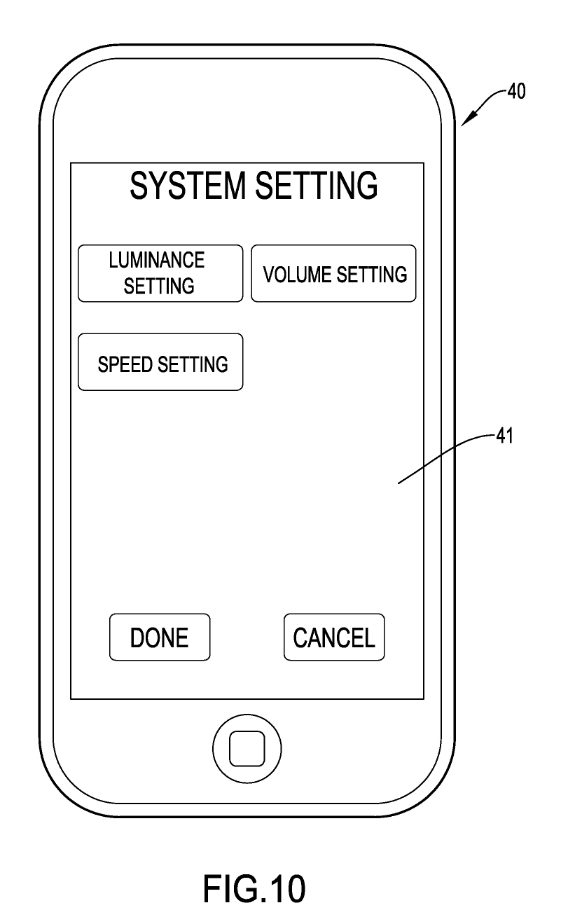

As shown in FIG. 10, the functional item of “SYSTEM SETTING” is disclosed. The user interface 41 further shows functional items of “LUMINANCE SETTING”, “VOLUME SETTING”, and “SPEED SETTING” when the user selects “SYSTEM SETTING” shown in FIG. 6. When the user selects “LUMINANCE SETTING” shown in FIG. 10, the luminance of the display panel 21 may be adjusted by the user. When the user selects “VOLUME SETTING”, the volume of the speaker 30 may be adjusted by the user. When the user selects “SPEED SETTING”, the videos, animations, and the images may be played at the normal speed, 1.2 times normal speed, or 0.8 times normal speed.

When the audio and video data contents going to be played are selected and/or the related settings are adjusted and then “CONFIRM” shown in FIG. 6 is activated, the processing unit 221 reads the audio and video data contents stored in the storage unit 224 corresponding to the wireless control signal S_{WL} outputted from the wireless receiving unit 222 or the wired control signal S_{WR} outputted from the wired receiving unit 223 according to the audio and video control signal S_{C} involving information of the selected audio and video data contents and/or the adjusted related settings. Accordingly, the selected audio and video data contents are transmitted to the display panel 21 and/or the speaker 30 and displayed on the display panel 21 and/or through the speaker 30.

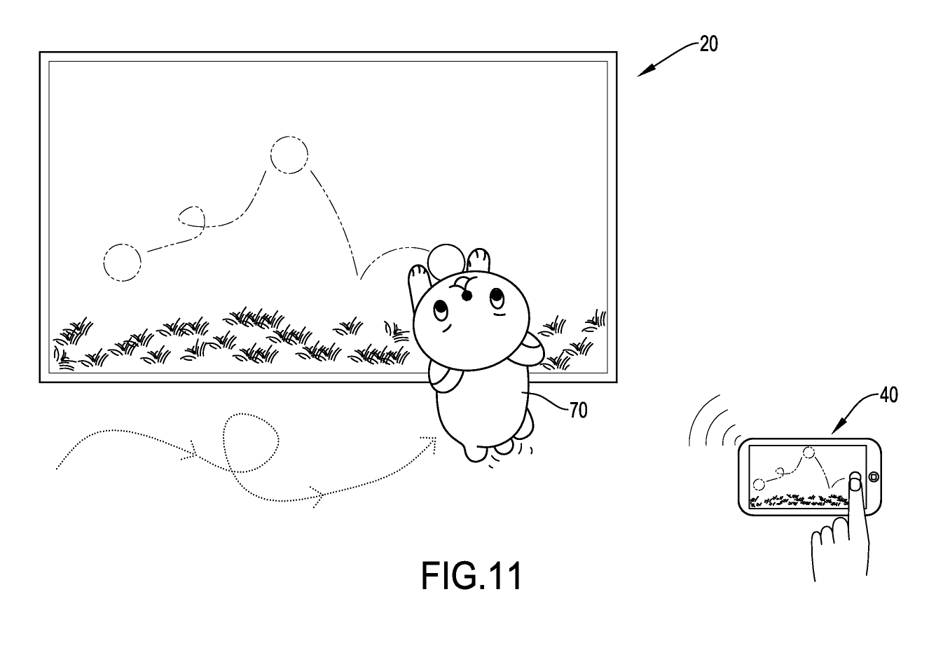

As shown in FIG. 11, the function of “SYNCHRONOUS PLAY” is implemented as the user operates the user apparatus 40 to synchronously play the audio and video data contents on the display apparatus 20 and through the speaker 30. In particular, the audio and video data contents are synchronously played by the display apparatus 20, the speaker 30, and the user apparatus 40 when the user selects “SYNCHRONOUS PLAY” shown on the user interface 41 in FIG. 6 and controls the audio and video data contents displayed on the user apparatus 40. The audio and video data contents, such as a ball and grasses displayed on the user apparatus 40 shown in FIG. 11 are dynamic and operable.

When the dynamic and operable audio and video data contents are selected and confirmed by the user on the user apparatus 40, the audio and video control signal S_{C} (as shown in FIG. 4 or FIG. 5) involving information of the selected dynamic and operable audio and video data contents is transmitted to the processing module 22 from the user apparatus 40. In addition, the user may touch and drag to move the dynamic and operable audio contents, such as the ball, grasses shown in FIG. 11, or a dog bone-shaped object (not shown), the dynamic and operable audio and video data contents are synchronously played on the display apparatus 20 and the speaker 30. Accordingly, it is to attract the pet dog 70 to chase, grab, or play with the dynamic and operable audio contents to attract pets' attention and activate pets' motion and facial expressions.

In this present disclosure, the audio and video data contents outputted from the display panel 21 and the speaker 30 and the dynamic and operable audio and video data contents synchronously displayed on the display panel 21 and the speaker 30 are provided to interest or excite the pets. Accordingly, the user controls the user apparatus 40 playing vivid and various audio and video data contents on the display panel 21 and/or through the speaker 30 so as to attract pets' attention and activate pets' motions and facial expressions, thus increasing interaction between pets and keepers thereof.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “having,” “has”, and “have,” are inclusive and therefore specify the presence of stated features, elements, and/or components, but do not preclude the presence or addition of one or more other features, elements, components, and/or groups thereof.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A human-pet interaction system comprising:
a pet container having a side plate that is transparent;
a display apparatus disposed on the pet container, the display apparatus having:
a display panel disposed on the side plate, the display panel having a display surface facing to an interior of the pet container; and
a processing module electrically connected to the display panel;
a speaker electrically connected to the processing module; and
a user apparatus;
wherein the user apparatus is configured to transmit an audio and video control signal to the processing module to control the display panel and the speaker to play audio and video data contents.

2. The human-pet interaction system as claimed in claim 1, wherein the processing module comprises:
a processing unit;
a wireless receiving unit connected to the processing unit and configured to receive the audio and video control signal in a wireless communication manner from the user apparatus and produce a wireless control signal according to the audio and video control signal;
a wired receiving unit connected to the processing unit and configured to receive the audio and video control signal in a wired communication manner from the user apparatus and produce a wired control signal according to the audio and video control signal; and
a storage unit connected to the processing unit and configured to store the audio and video data contents;
wherein the processing unit is configured to receive the wireless control signal or the wired control signal, and output the audio and video data contents to the display panel and the speaker according to the wireless control signal or the wired control signal.

3. The human-pet interaction system as claimed in claim 2, further comprising a cloud server host connected to the user apparatus via the Internet, wherein the user apparatus is configured to produce a data download signal to control the audio and video data contents stored in the cloud server host to be downloaded to and stored in the storage unit.

4. The human-pet interaction system as claimed in claim 3, wherein the user apparatus is further configured to transmit the audio and video data contents stored in the user apparatus to be stored in the storage unit according to the audio and video control signal.

5. The human-pet interaction system as claimed in claim 2, wherein the user apparatus is further configured to transmit the audio and video data contents stored in the user apparatus to be stored in the storage unit according to the audio and video control signal.

6. The human-pet interaction system as claimed in claim 1, wherein the user apparatus is further configured to transmit the audio and video data contents stored in the user apparatus to be stored in the storage unit according to the audio and video control signal.

7. The human-pet interaction system as claimed in claim 1, wherein the user apparatus has a human-pet interaction application, the user apparatus is configured to execute the human-pet interaction application to provide a user interface on a display screen of the user apparatus, wherein the user interface is an interface for operations of the human-pet interaction application.

8. The human-pet interaction system as claimed in claim 7, wherein the human-pet interaction application is configured to provide a play function for playing the audio and video data contents on the display panel and through the speaker.

9. The human-pet interaction system as claimed in claim 7, wherein the human-pet interaction application is configured to provide a download function for downloading the audio and video data contents stored in the cloud server host to the storage unit.

10. The human-pet interaction system as claimed in claim 7, wherein the human-pet interaction application is configured to provide a transmission function for transmitting the audio and video data contents stored in the user apparatus to the storage unit.

11. The human-pet interaction system as claimed in claim 1, wherein the audio and video data contents are synchronously played by the display apparatus, the speaker, and the user apparatus.

12. The human-pet interaction system as claimed in claim 1, wherein the audio and video data contents are synchronously played on the display apparatus and through the speaker by operating the user apparatus.

13. The human-pet interaction system as claimed in claim 1, wherein the speaker is disposed inside the display apparatus.

14. The human-pet interaction system as claimed in claim 1, wherein the speaker is disposed on the display apparatus.

15. The human-pet interaction system as claimed in claim 1, wherein the speaker is disposed on the pet container.

16. The human-pet interaction system as claimed in claim 1, further comprising:
two fixing elements disposed on two ends of an outer surface of the side plate; wherein the two fixing elements and the outer surface of the side plate form a slot structure; and
the display apparatus is mounted in the slot structure.

17. The human-pet interaction system as claimed in claim 1, wherein the display apparatus is a liquid crystal display (LCD), a plasma display panel (PDP), or a light-emitting diode display (LED display).

18. The human-pet interaction system as claimed in claim 1, wherein the user apparatus is a smart phone, a tablet computer, a notebook computer, or a personal computer.
